(19) United States
(12) Patent Application Publication
(10) Pub. No.: US 2011/0236665 A1
(43) Pub. Date: Sep. 29, 2011

(54) WIPE MATERIALS COMPRISING REGENERATED PLANT-PROTEIN FIBRES

(76) Inventors: Caroline Roque, L'Isle-Adam (FR); Jeremie Peyras-Carratte, Chambly (FR); Guillaume Martins, Mantes La Jolie (FR); Christian Larcheron, Jouy Le moutier (FR)

(21) Appl. No.: 13/122,001

(22) PCT Filed: Oct. 2, 2009
(86) PCT No.: PCT/US09/59406

§ 371 Date: Jun. 9, 2011

(30) Foreign Application Priority Data
Oct. 3, 2008 (GB) 0818104.2

(51) Int. Cl. B32B 9/02; D04H 13/00; D04H 1/60

(52) U.S. Cl. 428/219; 442/327; 442/416

(57) ABSTRACT

A thermo-bonded non-woven fibrous wipe material is described, in which at least some of the fibres are regenerated plant-protein fibres. Also described is a method of making such a thermo-bonded fibrous non-woven wipe material, comprising the steps of forming a non-woven web of fibres, the web containing heat-sensitive material, and applying heat to the web to melt the heat-sensitive material and thereby cause fibres in the web to be bonded together; wherein at least some of the fibres are regenerated plant-protein fibres. The regenerated plant-protein fibres may comprise soybean protein.

The present disclosure relates to wipe materials, in particular thermo-bonded non-woven fibrous wipe materials. The disclosure is concerned more especially, but not exclusively, with wipe materials intended for use in articles for wiping surfaces in various environments.

### BACKGROUND

Wiping articles in a form known as “wipes” are widely used by consumers in various environments, including domestic, industrial, hospital and food industry environments, for wiping surfaces such as floors and work surfaces, for example the surfaces of kitchen and bathroom furniture and appliances. As used herein, the term “wipe” means a piece of web material the characteristics of which are such that it is effective per se for the wiping of a surface (i.e. it can be handled and used to wipe a surface without, for example, being layered with, or laminated to, another material) with both surfaces of the web material normally providing a wiping action. Many different types of wipe are currently available, ranging from paper towels to textile dish cloths and floor cloths.

The type of web material used for a wipe depends on the cleaning/wiping function that the wipe is required to perform, and its intended lifetime. Some wipes are intended to be used dry (for example, paper towels that are used to mop-up spilt liquid) and others are intended to be used in a damp or wet condition. Wipes can be categorized, depending on their durability, as “disposable” (meaning that the wipe is intended to be discarded. immediately after use), “semi-disposable” (meaning that that the wipe can be washed and re-used a limited number of times), or “reusable” (meaning that the wipe is intended to be washed and re-used for an indefinite number of times, depending on the use to which it is subjected). A desirable characteristic of many wipe materials is an ability to absorb a comparatively large amount of liquid, typically water. A wipe material should also have a tensile strength, when wet, that is appropriate for its intended use.

Examples of web materials that are currently used for wipes include: spun-bond non-woven materials for wipes in the “disposable” category, spun-lace non-woven materials for wipes in the “disposable” and “semi-disposable” categories; and knitted, woven, and thermo-bonded non-woven materials for wipes in the “reusable” category.

Thermo-bonded non-woven materials formed from viscose fibres are widely used for reusable wipe materials: they offer the advantages of being comparatively straightforward and economical to produce, of having an attractive feel and appearance, and of being able to absorb a comparatively large amount of water.

Although viscose wipes are highly popular, environmental concerns are leading in many areas to an increasing demand from consumers for a wider choice of products that are based on natural materials, particularly materials derived from plants.

In the field of wipe materials, products comprising bamboo fibres have already been described in WO 2007/084296. In that case, however, the wipe materials are intended for use in a wet or damp condition and are described for their ability to retain an hygienic appearance if left in that condition, and for their “wipeability”.

### SUMMARY

The present disclosure is concerned with increasing consumer choice through the provision of non-woven materials comprising alternative plant-based fibres, advantageously materials which can be manufactured using known thermo-bonding processes to provide acceptable performance characteristics for use as re-usable or disposable wipe materials.

The present disclosure provides a thermo-bonded fibrous non-woven wipe material, in which at least some of the fibres are regenerated plant-protein fibres.

The disclosure is based in the discovery that regenerated plant-protein fibres are not only suitable for making thermo-bonded materials that have sufficient tensile strength to be used as wiping articles but that the wiping articles so obtained have good water-absorption capabilities.

### DETAILED DESCRIPTION

Wiping material in accordance with the disclosure can be produced using manufacturing equipment that is readily-available and well-understood for the manufacture of thermo-bonded fibrous non-woven materials. The raw materials for the fibres come from renewable natural resources, many of which are readily available and comparatively cheap.

As used herein. “thermo-bonded non-woven material” means a textile material formed by applying heat to a non-woven web of fibres containing heat-sensitive material, to melt the heat-sensitive material and thereby cause fibres in the web to be bonded together. The heat-sensitive material may be in the form of fibres (including bi-component fibres) or powders.

As used herein, “regenerated plant-protein fibres” means artificial fibres manufactured (for example, by wet spinning) from regenerated plant-protein (typically in combination with other components). Known examples of regenerated plant-protein fibres have been made using peanut, corn-gluten and soybean proteins, and have been used for manufacture clothing textiles. Methods for the production of regenerated plant-protein fibres have been described in, for example, CN-A-1 286 325 and WO 2003/056076 (both in the name of Guangi) and U.S. Pat. No. 5,580,499 (Uy).

A material in accordance with the disclosure may comprise at least 10% by weight of regenerated plant protein-fibres, and preferably comprises at least 70% by weight of such fibres (for example at least 80%, or at least 90%). In embodiments of the invention described herein, the fibres comprise regenerated soybean protein. Manufacturers of fibres from regenerated soybean protein claim that the manufacturing process does not pollute the environment and that the soybean residue remaining after extraction of the protein can be used as feedstuff.

A material in accordance with the disclosure may also comprise fibres of other materials. Any fibres known to be suitable for use in thermo-bonded non-woven wipe materials and compatible with the regenerated plant-protein fibres can be used. Examples of fibres of other materials are synthetic polymer fibres, for example fibres of polyester polyamide, polypropylene, polyvinyl alcohol or mixtures thereof; regenerated plant-cellulose fibres; naturally-occurring plant fibres (i.e. fibres derived directly from plants), for example cotton fibres; and other regenerated fibres, for example viscose fibres. Mixtures of such fibres can also be used.

The fibres of a material in accordance with the disclosure can be thermally-bonded together in any suitable way, for example by a suitable heat-sensitive binder material. Examples of binder materials are synthetic thermoplastic polymer binder materials, for example polypropylene and polyester; and plant-derived thermoplastic binder materials, for example polylactic acid (PLA).

Materials in accordance with the disclosure may have any basis weight appropriate for wipe materials. Examples of materials described herein have basis weights in the range of from 120 to 150 g/m². However, by adjusting the manufacturing parameters, materials of higher and lower basis weights could be produced extending, for example, from 80 to 250 g/m² or even from 15 to 300 g/m² (or higher, if required).

Materials in accordance with the disclosure should have sufficient tensile strength and liquid-absorption capabilities appropriate for use in wiping articles. Examples of materials described herein have an average tensile strength of at least 100 N/51 mm and are able to absorb an amount of water equal to at least 17 times their dry weight, in some cases at least 19 times their dry weight.

As used herein, the term “average tensile strength” means the average of the tensile strengths of a material measured in the machine and cross-machine directions.

A material in accordance with the disclosure may be provided in pieces of a suitable size and shape for use as wipes. A size of 30 cm by 30 cm is typical for a domestic wipe but wipes of smaller or larger sizes could be produced, depending on their intended use. As an alternative, the material may be bonded to another material (for example a textile material (which may be of woven, knitted or non-woven construction), a sponge material or a sponge-cloth material) to form a cleaning article. As a further alternative, a material in accordance with the disclosure may be used in the head of a mop for floor-cleaning.

A material in accordance with the disclosure is typically formed from a non-woven web of fibres containing heat-sensitive material, to which heat is applied to melt the heat-sensitive material and thereby cause fibres in the web to be bonded together. The heat-sensitive material may be in the form of fibres (including bi-component fibres) or powders. When heat-sensitive fibres are employed, a typical material for the fibres is polyester: however, fibres of any other suitable materials can be used. The non-woven web of fibres can be formed in any suitable way, for example by using the well-known carding and cross-lapping process or by using web-forming equipment of the type described in WO 05/044529 (Form-Fibre Denmark APS). The web of fibres may then be reinforced in any suitable way, for example by needle-tacking, stitching or hydroentanglement, before heat is applied to it (for example in an oven). Following the thermo-bonding process, the web may be calendered.

Wipe materials in accordance with the disclosure are described in greater detail in the following non-limiting examples. All parts and percentages quoted are by weight unless otherwise indicated.

The examples used the following materials, equipment and test methods:

### Materials:

Regenerated soybean-protein fibres: regenerated raw white fibres having a denier of 1.5 dtex and a length of 38 mm, commercially available from Shanghai Winshow Soybeanfibre Industry Co., Ltd. of Shanghai, China.

Bleached regenerated soybean-protein fibres: regenerated bleached white fibres having a denier of 1.5 dtex and a length of 38 mm, commercially available from Shanghai Winshow Soybeanfibre Industry Co., Ltd. of Shanghai, China.

Viscose fibres: viscose fibres having a denier of 1.7 dtex and a length of 38 mm, commercially available under the trade name “Lyocell” from Lenzing AG of Lenzing, Austria.

Polyester fibres: polyester fibres having a denier 1.0 dtex and a length of 38 mm, commercially available from INVISTA of Hattersheim, Germany.

Mono-component thermo-bonding fibres: polyester fibres having a denier of 1.7 dtex and a length of 60 mm, commercially available under the trade designation “KE170” from EMS Griltech of Domat, Switerland.

Bi-component thermo-bonding fibres: bi-component polyester fibres having a denier of 2.2 dtex and a length of 38 mm, commercially available from INVISTA of Hattersheim, Germany.

PLA thermo-bonding fibres: PLA low-melt fibres having a denier of 4.0 dtex and a length of 51 mm, commercially available under the trade name “Ingeo” from NatureWorks LLC of Minnealopis, USA.

Fiber opening and blending equipment: conventional equipment (available, for example, from Laroche S.A. of Cours la Ville, France).

Web-forming apparatus: a conventional carding machine (available, for example, from Nuova Cosmatex S.R.L. of Benna, Italy) followed by a conventional cross-lapping machine and a conventional needle tacker (both available, for example, from Automatex Nonwoven of Pistoia, Italy).

Oven: a conventional oven (available, for example, from Cavitec AG of Tobel, Switzerland).

Calendering machine: a conventional machine (available, for example, from Strahm Hi-Tex Systems AG of Lengwil-Oberhofen, Switzerland).

### Test Methods

### Measurement of Water Absorption Capabilities of Samples

Using a conventional die-cutting punch tool, ten pieces of material each having a width of 100 mm and a length of 100 mm were cut randomly from a web of non-woven fibrous material. The dry weight (W1) of each piece was recorded.

The pieces were then immersed in water at room temperature until they were fully soaked. Each piece was squeezed by hand 10 times while still in the water, in order to completely remove any air. It was then taken out of the water and allowed to drip for 30 seconds while being held from one corner, and its weight when wet (W2) was recorded.

The water absorption in terms of grams of water absorbed per gram of non-woven material was calculated for each piece as (W2−W1)/W1. The average water absorption for the ten pieces was then calculated and recorded.

Measurement of Tensile Strength of Samples when Wet

Using a conventional die-cutting punch tool, ten pieces of material each having a width of 51 mm and a length of 100 mm were cut from a web of non-woven fibrous material, five of the pieces being cut in the machine direction of the web and the other five in the cross-machine direction. The pieces were rinsed thoroughly in water and then wrung by being passed between the two rubber rollers of a conventional laboratory mangle, adjusted so that the rollers were in contact.

The wet pieces were stored in a sealed plastic bag, from which they were removed one at a time to be placed, widthwise, between the vertically-spaced jaws of an Instron dynamometer, Type 1122, available from Instron, High Wycombe, UK, so that the tensile strength of each piece could be measured. The operating parameters of the dynamometer were as follows: crosshead speed, 300 mm/min; load range cell, 1 kN; separation between jaws, 51 mm. The average of the ten measurements of tensile strength was calculated and recorded (in N/51 mm).

### Example 1

A thermo-bonded non-woven web material was formed using a fibre mixture comprising 90% soybean fibre and 10% mono-component thermo-bonding fibres. The fibre bales were opened and the fibres blended in the required relative quantities before being fed to the web-forming apparatus, in which a carded and cross-lapped, needle-tacked, non-woven web of fibres was formed in the conventional manner. The web was passed, at a speed of 1 m/min, through the oven which was operated at a temperature of 190° C. to melt the thermo-bonding fibres and thereby cause them to bond to the other fibres in the web, and was then passed through the calendering machine. A thermo-bonded non-woven fibrous web material was produced that had a basis weight in the range of from 120 to 150 gm/m² and a thickness of from 3 to 4 mm. Wipe samples were cut from the thereto-bonded web and the water absorption capabilities and the tensile strength of the samples were measured.

### Example 2

Example 1 was repeated except that the non-woven material was formed using a fibre mixture comprising 80% soybean fibres, and 20% mono-component thermo-bonding fibres.

### Example 3

Example 2 was repeated except that the non-woven material was formed using a fibre mixture comprising 80% soybean fibres,10% polyester fibres and 10% mono-component thermo-bonding fibres.

### Example 4

Example 2 was repeated except that the 20% mono-component thermo-bonding fibres was replaced by 20% bi-component thermo-bonding fibres.

### Example 5

Example 1 was repeated except that the non-woven material was formed using a fibre mixture comprising 70% bleached soybean fibres, 15% polyester fibres and 15% mono-component thermo-bonding fibres.

### Example 6

Example 5 was repeated except that the 70% soybean fibres was replaced by 35% soybean fibres and 35% viscose fibres.

### Example 7

Example 5 was repeated except that the 70% soybean fibres was replaced by 10% soybean fibres and 60% viscose fibres.

### Example 8 (Comparative Example)

Example 5 was repeated except that the 70% soybean fibres was replaced by 70% viscose fibres.

The results of the measurements of the tensile strength and the water absorption capabilities of the samples are illustrated in the accompanying FIGS. 1 and 2 respectively.

FIG. 1 shows that the average tensile strengths of the samples (i.e. the average of the tensile strength measurements in the machine direction and the cross-machine direction of the materials) were all above 100 N/51 mm.

FIG. 2 shows that all of the samples exhibited good water absorption capabilities of at least 17 times their dry weight, with some of the samples (including those produced by Examples 6 and 7, in which the thermo-bonding fibres were PLA thermo-bonding fibres) exhibiting water absorption capabilities of more than 19 times their dry weight.

### CONCLUSIONS

The wipe samples of Examples 1 to 7 above, made using regenerated soybean-protein fibres, are at least comparable in terms of their average tensile strength and water-absorption capabilities to equivalent samples of Comparative Example 10, made using viscose fibres. Consumer demand fix a wider choice of wipes that are based on plant-derived materials can thus be met, without sacrificing performance, with the added advantages that the preferred basic raw material (soybean) is a renewable resource and comparatively inexpensive and that the production process is widely used and well-understood. If required, as shown by the samples of Examples 8 and 9, soybean fibres can be used in a wipe in combination with viscose fibres, while still maintaining the required tensile strength and absorption capabilities.

Wipes produced from web materials as described above constitute, in themselves, articles for wiping surfaces such as floors and work surfaces. In that case, both surfaces of a wipe usually provide a wiping action. Typically, both surfaces of the wipe will provide the same wiping action but that is not necessarily always the case: through modification of the web-making process, or subsequent treatment of the finished web (for example by a coating process or the application of abrasive particles), the two sides of a wipe may differ, for example, in terms of their absorption characteristics or their abrasive natures. If the wipe material has a sufficiently-high basis weight, it can be used in the head of a mop for floor-cleaning

Alternatively, wipes produced from web materials as described above may be bonded to other materials to provide articles for wiping surfaces. The other material may simply provide a support for the wipe but, more usually, will be another material suitable for use in cleaning surfaces (for example, a material that provides a different wiping action). The two materials may be laminated together, for example by means of a suitable adhesive.

The second material may, for example, be formed from a textile material, a sponge material or a sponge-cloth material. Alternatively, the second material may be a non-woven abrasive material.

1-20. (canceled)

21. A thermo-bonded non-woven fibrous wipe material comprising a plurality of fibers, wherein at least some of the fibers are regenerated plant-protein fibers.

22. The material of claim 1, comprising at least 10% by weight of regenerated plant protein fibers.

23. The material of claim 1, wherein the regenerated plant-protein fibers comprise soybean protein.

24. The material of claim 1, wherein at least some of the fibers are synthetic polymer fibers, regenerated plant cellulose fibers, naturally-occurring plant fibers, or mixtures thereof

25. The material of claim 1, wherein the fibers are bonded together by a thermoplastic polymer binder material.

26. The material of claim 1, wherein the fibers are bonded together by a plant-derived thermoplastic binder material.

27. The material of claim 1, wherein the material has a basis weight in the range of from 80 to 250 g/m².

28. The material of claim 1, wherein the material has an average tensile strength of at least 100 N/51 mm.

29. The material of claim 1, wherein the material being able to absorb an amount of water equal to at least 17 times its dry weight.

30. A cleaning sheet comprising:
a plurality of regenerated plant-protein fibers;
a plurality of thermoplastic fibers;
wherein the fibers bond to one another a mutual points of contact for form a nonwoven web of fibers.
